(19) United States
(12) Patent Application Publication
(10) Pub. No.: US 2007/0231433 A1
(43) Pub. Date: Oct. 4, 2007

(54) Pack for doughy food products in portions

(76) Inventor: Fernando Calvo Mondelo, Madrid (ES)

Correspondence Address: WILLIAM COLLARD;COLLARD & ROE, P.C., 1077 NORTHERN BOULEVARD, ROSLYN, NY, 11576, US

(21) Appl. No.: 11/729,721

(22) Filed: Mar. 29, 2007

(30) Foreign Application Priority Data
Mar. 29, 2006 (ES) U 200600732

(51) Int. Cl. A21D 10/02

(52) U.S. Cl. 426/128

(57) ABSTRACT

Pack for doughy food products in portions which comprises a protective case in the shape of a book box made up of a plastic monoblock part with two covers facing each other and joined to a spine, capable of being swung open, and, jutting out from the covers, lateral edges facing each other, that fit together and/or overlap one another to laterally close the case which is kept shut by the use of tabs that may be unfastened; fixing elements are used inside the pack as a support for the single-portion packets of the doughy product, held to the support by means of their common plastic film wrapping.

### OBJECT OF THE INVENTION

The present invention refers to a pack for doughy food products in portions.

### BACKGROUND OF THE INVENTION

The use of vending machines for different products, for example foodstuffs, is currently widespread.

Some of these products have a doughy texture, for example chocolate, liable to be contaminated or whose consumption, if it touches the outer part of the pack that is usually dirty and handled, becomes unhygienic. Besides, its pouring or extraction from the pack sometimes causes stains.

This reduces its effectiveness, apart from becoming a health and hygiene problem.

These disadvantages reduce the attractiveness of the product, besides implying a problem of hygiene, and are solved by the use of the pack in this invention.

### DESCRIPTION OF THE INVENTION

The pack of the invention has an optimum embodiment in order to preserve the hygienic conditions of doughy food products, for example, chocolates and their contents, for which reason its use in vending machines is very appropriate. Besides, it has means to facilitate the extraction or pouring of the product without staining oneself and without risking hygienic conditions.

In accordance with the invention, the pack comprises a book box-type protective case, normally made up of a plastic, monoblock piece with two covers facing each other and joined to the spine, may be swung open, and, jutting out from the covers, lateral edges facing each other, that fit together and/or overlap one another, thus laterally closing the case which is kept shut by means of tabs that may be unfastened to open it.

Inside the case are the single-portion packets of the doughy product, held on a support by their common plastic film wrapping, preferably transparent, that is torn open to remove the packets. The support stays fastened inside the case by means of fixing elements fitted to it.

The packets are tubular and made up a folded, plastic part with longitudinal thermowelds and other transversal welds at the ends. Tearing means have been included at least at one of the thermowelded ends, that, on being used, create an opening through which the product is poured out, without it staining or coming into contact with the outer part of the pack and causing possible contamination.

### BRIEF DESCRIPTION OF THE DRAWINGS

FIG. 1 shows a general view of the pack in the invention.

FIG. 2 shows a view of FIG. 1 with the pack open and the support for the single-portion packets removed.

FIG. 3 shows a detailed view of one of the invented pack's single-portion packets.

FIG. 4 shows a view of FIG. 3 with the packet open.

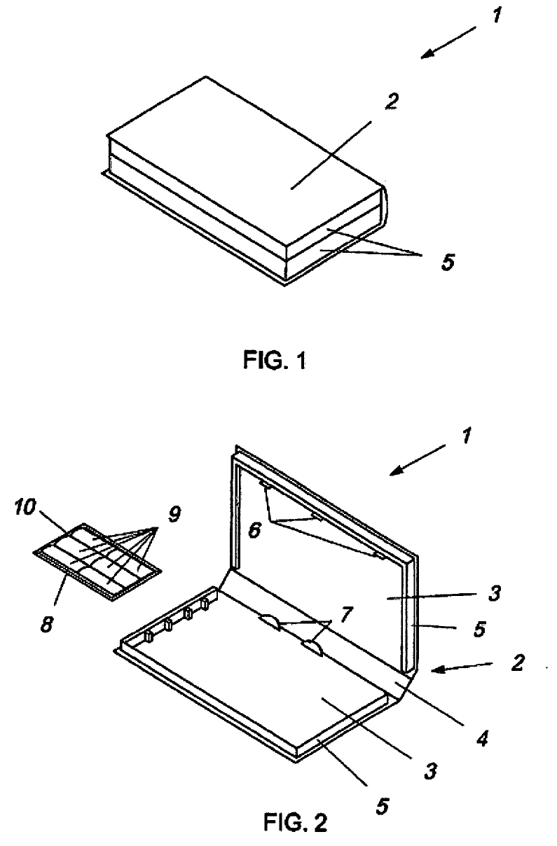

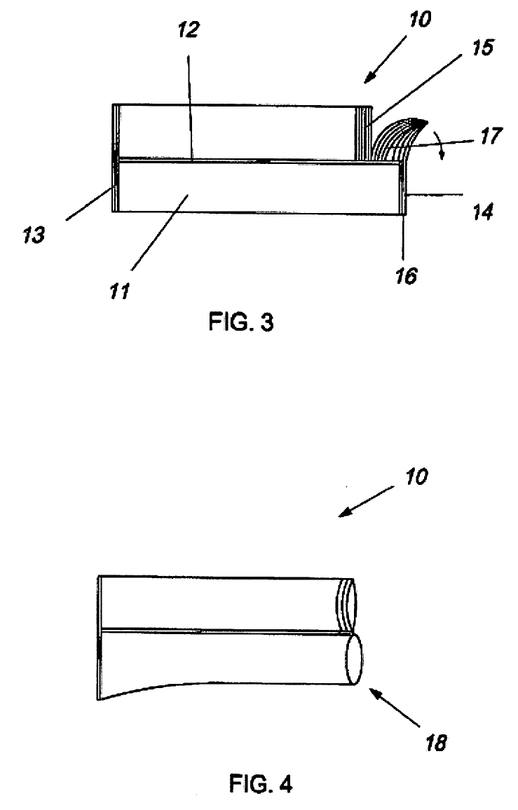

### DESCRIPTION OF A PRACTICAL EMBODIMENT OF THE INVENTION

The invented pack 1 comprises a rigid-enough, plastic monoblock protective case 2, in the shape of book box with two covers 3 facing each other and joined together at the spine 4, capable of being swung open, and, jutting out from the covers, lateral edges 5 facing each other, that fit together or overlap one another, thus laterally closing the case, using tabs 6 too to keep the case closed and unfastened to open it.

Inside the case, locking elements 7 are used as a support 8 for the single-portion packets 9 of the doughy product, which stay fixed to the support on the unit being sheathed or wrapped in a preferably transparently film 10, the packets being ideally placed in rows as may be seen in the figures.

As for the packets 10, they are tubular-type, made up a folded, laminated part 11 with longitudinal thermowelds 12 and two transversal 14 ends 13, having foreseen that one of them 14 is asymmetric and defines a longer area 15 and another shorter one 16 in a lengthwise direction. A line weakened by punching 17 has been used in area 15 that is out of line with the thermoweld constituting the shorter area 16. When tearing along the weakened line of area 15 until reaching area 16, the tear continues along a non-thermowelded part and the packet opens in the shape of the mouth of a flute 18, creating a nozzle through which the doughy product is cleanly poured out, without coming into contact with the outer part of the packet.

To decorate the packet, several different means may be used, from serigraphy or direct dabbing printing, although in this example of the invention a tubular label 17 surrounding the packet has been used which reduces the risk of inks penetrating the wall of the packet and reaching the foodstuff.

Having sufficiently described the nature of the invention, as well as the way to embody it in practice, it must be emphasized that the previously indicated layouts, represented in the attached drawings, may be modified in detail as long as they do not alter the fundamental principle.

1. Pack for doughy food products in portions; characterised by comprising a protective case in the shape of a book box made up of a plastic monoblock part with two covers facing each other and joined to a spine, capable of being swung open, and, jutting out from the covers, lateral edges facing each other, that fit together and/or overlap one another to laterally close the case which is kept shut by the use of tabs that may be unfastened; fixing elements are used inside the pack as a support for the single-portion packets of the doughy product, held to the support by means of their common plastic film wrapping.

2. Pack according to claim 1 where the single-portion packets are tubular-type, made up a folded, plastic part with longitudinal thermowelds and two transversal ends; characterised by one of the end thermowelds being asymmetric and defining a longer area and another shorter one in a lengthwise direction, the longest part having a weakened line that is out of line with the thermoweld in the shorter area so as to enable it to be torn open in the shape of the mouth of a flute and make a nozzle.
